(19) United States
(12) Patent Application Publication
(10) Pub. No.: US 2014/0291180 A1
(43) Pub. Date: Oct. 2, 2014

(54) INNER FRAME WITH AT LEAST ONE CREASING LINE, CONTAINER CONTAINING SAME, USE OF SUCH AN INNER FRAME BLANK AND METHOD FOR INCREASING STABILITY OF A CONTAINER

(71) Applicant: Bodo Lutzig, Chavornay (CH)

(72) Inventor: Bodo Lutzig, Chavornay (CH)

(73) Assignee: PHILIP MORRIS PRODUCTS S.A., Neuchatel, ` (CH)

(21) Appl. No.: 13/991,944

(22) PCT Filed: Dec. 7, 2011
(86) PCT No.: PCT/EP11/72106

§ 371 Date: Aug. 9, 2013

(30) Foreign Application Priority Data
Dec. 7, 2010 (EP) 10194017.9

(51) Int. Cl. A24F 15/12; B31B 1/90

(52) U.S. Cl. CPC A24F 15/12; B31B 1/90
USPC 206/245; 206/268; 493/89

(57) ABSTRACT

An inner frame for containers, preferably hinge lid containers, for consumer goods comprises a center panel (23) and optionally a left (21) and right (22) side panel, each adjacent to the center panel (23), wherein the inner frame comprises at least one, preferably at least two creasing lines (6) extending at least partially along the width of the inner frame. The inner frame enhances stability of a container for consumer goods comprising the inner frame. A method of increasing the stability of a container for consumer goods comprises inserting the inner frame into the box of a container such that at least a portion of the inner frame projects beyond the open end of the box of the pack.

The present invention relates to a novel container, preferably a hinge lid container, with a creased inner frame blank for consumer goods. The container finds particular application as a container for elongate smoking articles, such as cigarettes.

It is known to package consumer goods such as, for example, elongate smoking articles in containers formed from folded laminar blanks. For example, elongate smoking articles, such as cigarettes and cigars, are commonly sold in hinge lid containers having a box for housing the smoking articles and a lid connected to the box about a hinge line extending across the back wall of the container. Such hinge lid containers may comprise an inner frame that is arranged within the box, between the box front wall and side walls and the consumer goods within the housing.

Where present the inner frame typically extends above the box and reaches into the lid when the pack is closed. The inner frame may facilitate the closure of the pack and may protect the consumer goods within the pack.

It is known to increase the stability of containers for consumer goods by increasing the specific weight of the material used. For example, containers made from cardboard are usually used for the manufacture of containers for consumer goods and thus the specific weight or grammage of the cardboard used may be increased if increased stability is to be achieved.

However, increasing the cardboard weight may be costly. It has the additional disadvantage of increased weight of the overall pack. Alternatively, it would be desirable to reduce the weight of the container without reducing the overall structural strength of the container. Also, it may be desirable to achieve these advantages without changing the outer appearance of the container which is visible to the consumer.

It is an object of the present invention to provide a container, preferably a hinge lid container, for consumer goods which meets these needs and provides for an improved stability without the need of costly changes to the production material and without changing the outer appearance of the container.

According to the invention, this is achieved by a novel inner frame blank for a container and a container for consumer goods with such a novel inner frame blank. The invention is further directed to the use of the novel inner frame to improve the stability of a container and to a method of increasing the stability of a container for consumer goods.

According to the invention, an inner frame blank for a container for consumer goods with a lid and a box is provided, wherein the inner frame comprises a center panel and optionally a left side panel and optionally a right side panel, each adjacent to said center panel, wherein said inner frame comprises at least one and preferably at least two creasing lines extending substantially transverse partially or completely across said center panel.

Throughout the invention the terms “front”, “back”, “upper”, “lower”, “side”, “top”, “bottom” and other terms used to describe relative positions of the components of the containers and inner frame blanks according to the invention refer to the container in an upright position with the lid at the top end and, where there is a hinge, with the hinge at the back. When describing containers and inner frame blanks according to the present invention, these terms are used irrespective of the orientation of the container or inner frame blanks being described.

The terms “left” and “right” are used with reference to side walls of the container or the inner frame blank when the container or the inner frame blank is viewed from the front in its upright position. The term “longitudinal” refers to a direction from bottom to top or vice versa. The term “transverse” refers to a direction perpendicular to the longitudinal direction.

The expression “at least one substantially transverse creasing line extending partially or completely across said center panel” means that the at least one creasing line extends, provided left and right side panels are present, partially or completely from the left side panel to the right side panel and, provided no left and right side panels are present, partially or completely from the edge of the center panel where a potential left side panel would be attached to the edge of the center panel where a potential right side panel would be attached. If the inner frame blank with the at least one creasing line is inserted in a regular hinged lid container, such as a regular cigarette pack, in its upright position with the hinge and the opening being at the top of the pack the at least one creasing line will extend partially or completely and substantially horizontal, i. e. substantially transverse, from the left side panel to the right side panel (provided left and right side panels are present adjacent to the center panel) or from the left edge to the right edge of the center panel (provided no left and right side panels are present). In the described arrangement of the inner frame blank in a regular hinged lid cigarette pack the term “transverse” means thus consistent with the proceeding paragraph a direction perpendicular to the longitudinal direction of the regular hinged lid cigarette pack.

Conventional hinge lid containers have typically a higher stability in the longitudinal direction due to double layers of the glued sidewalls and the connection to the stabilizing bottom and top panels. The stability of a conventional hinge lid container is relatively lowest in a transverse direction close to the upper end of the box front wall. This is due to the relatively large size of the front wall and the open end structure towards the opening of the box.

The at least one, but preferably two creasing lines in the inner frame blank increase the rigidity of the inner frame in a transverse direction and decrease the stability of the inner frame in a longitudinal direction. A container with such an inner frame has an increased stability in a transverse direction, and in particular close to the upper end of the box front wall. The reduction in the longitudinal stability of the inner frame is compensated by the overall higher stability of the container in longitudinal direction. It is therefore possible to either increase the stability of a container of consumer goods without changing the thickness or weight of the cardboard used or to maintain the stability of the container and reduce the thickness or weight of the cardboard used. Such a container has therefore a high quality structure at a reduced cost. As the at least one and preferably at least two creasing lines are on the inner frame, the stabilizing feature is not visible from the outside of the container.

Preferably, the at least one and preferably at least two creasing lines extend from at least the right edge of said left side panel to at least the left edge of said right side panel, preferably essentially over the entire width of said inner frame and then also over the left and right side panels. Preferably, the at least one and preferably at least two creasing lines are linear or curved. A curved creasing line increases simultaneously the stability of the inner frame in a longitudinal and in a transverse direction. A curved creasing line has the additional benefit that it may be used also for decorative purposes.

Preferably, at least two creasing lines are present which are linear and substantially parallel to each other. Preferably the distance between the two creasing lines is between about 0.5 mm and about 3.0 mm. Preferably the creasing lines and the mating edges of said right and left side panels and the center panel form an angle of about 90 degrees.

The inner frame may be formed from any suitable materials including, but not limited to, cardboard, paperboard, plastic, or combinations thereof. Preferably, the inner frame is formed from an optionally folded laminar cardboard blank or paperboard blank, and preferably this cardboard or paperboard has a weight of between about 100 grams per square meter and about 350 grams per square meter. Short-grain cardboard or short-grain paperboard (which will be defined below in conjunction with the discussion of the container) are the most preferred materials for the inner frame.

The invention is further directed to a container for consumer goods comprising a box, a lid which is preferably hingedly connected to the box and an inner frame blank according to the invention. Preferably, the inner frame is inserted into said box such that it extends partially beyond the upper end of the box in the open position of the container but such that the at least one and preferably at least two creasing lines are not visible. This means that the at least one and preferably at least two creasing lines are preferably covered by the front wall of the box of the container.

The invention is further directed to a method of increasing the stability of a container, preferably a hinge lid container, for consumer goods, comprising the steps of providing a container comprising a box with an open end and a lid, providing an inner frame blank, the inner frame blank comprising at least one and preferably at least two creasing lines extending partially or completely across said inner frame blank and inserting said inner frame blank into said box such that at least a portion of said inner frame blank projects beyond said upper end of said box.

The container may be formed from any suitable materials including, but not limited to, cardboard, paperboard, plastic, or combinations thereof. Preferably, the container is formed from one or more folded laminar cardboard blanks, and preferably the cardboard has a weight of between about 100 grams per square meter and about 350 grams per square meter. Among cardboards and papers, short-grain and long-grain variants can be distinguished, as pointed out in the following.

During paper and cardboard manufacturing, the product-forming material is deposited on a fast-moving belt. This has the effect that the long fibers in the material preferably orient themselves in longitudinal direction. Depending on whether the pre-cut sheet (from which the individual components of containers for consumer goods are cut) is later cut along or across the finished material web, the long fibers in the pre-cut sheet are arranged across, i.e. perpendicular to, the longitudinal axis of the pre-cut sheet (short-grain) or along, i.e. parallel to, the longitudinal axis of the pre-cut sheet (long-grain). If the direction of the creasing lines according to the present invention is the same as the direction of the long fibers in the pre-cut sheet, an additional increase in the stability of the inner frame and container according to the invention can be observed. Thus, production of the container by using short-grain paper or short-grain cardboard is preferred. It is particularly preferred that the container and the inner frame are both made from short-grain materials, such as short-grain paper and/or short grain cardboard. This achieves maximum stability.

The base material for the inner frame just as for the container may have a thickness of between about 0.1 and about 3 mm, preferably between about 0.2 and about 2 mm and more preferably between about 0.3 and about 1 mm.

Usually, the creasing lines according to the invention are created during the step of cutting or punching out the inner frames of large sheets of base material.

Conventional cutting units comprise a roller and a corresponding counter roller between both of which the base material is transported by simultaneous circular motion of both rollers. This circular motion transports the base material through a small gap between both rollers. A knife or knife like instrument is mounted on the roller, and the counter roller is equipped with a mating recess which the knife edge penetrates to cut the base material.

To create the creasing lines of the present invention, the roller of the cutting unit is equipped with one or more positive rulers, and the counter roller is equipped with one or more corresponding negative channels. When the base material is transported through the small gap between the roller and the counter roller, pressure is applied by the rulers to one side of the base material. As a consequence, the base material is forced into the mating negative creasing channel, thus, creating a crease with the same shape as the rulers.

In general, a crease is characterized by having substantially the same thickness as the base material. In other words, the thickness of the base material does not or only negligibly change when a crease or creasing line according to the present invention is applied.

A creasing line of the present invention is not to be mistaken for a scoring line. A scoring line, in contrast to a creasing line, is characterized by having a smaller thickness than the base material. To produce a scoring line, layers of base material are removed and the material's thickness (or diameter) is reduced. In contrast, to produce a creasing line, the base material is displaced, no material is removed and the material's thickness remains constant or is only negligibly changed.

A creasing line of the present invention is also not to be mistaken for a folding line. A folding line, in contrast to a creasing line but in similarity to a scoring line, is characterized by having a smaller thickness than the base material. To produce a folding line, the base material is folded which leads to compression of the material at the fold and a simultaneous reduction of the material's thickness (or diameter). In crossectional views a scoring line and a folding line have similar appearances. In both cases the thickness (or the diameter) of the material is reduced. However, for a scoring line part of the material is removed, whereas for a folding line the material is not removed but compressed.

As mentioned above, the inner frame of the present invention exhibits at least one and preferably at least two creasing lines extending at least partially along the width of the inner frame. Two creasing lines are indeed preferred. However, an inner frame blank with three, four, five, six, seven or more creasing lines is also possible.

The width of the creasing lines is, for example, between about 0.1 mm and about 5 mm, preferably between about 0.2 mm and about 4 mm and more preferably between about 0.3 and about 3 mm.

Due to the manufacturing process, the width and shape of the creasing lines correspond substantially to the width and shape of the creasing ruler. The cross-sections of the creasing ruler top, which top actually forms the crease, may have different shapes. For example, selected shapes are semicircle, semi-ellipse, triangle, quadrangle, square, pentagon, hexagon, semi-hexagon, or even more complex shapes, such as curved shapes. The preferred shape is the semicircle. The creasing channel has the same but inverted shape such that the creasing ruler fits substantially into the creasing channel. The width of the creasing ruler is, for example, between about 0.1 and about 5 mm, preferably between about 0.2 and about 4 mm and more preferably between about 0.3 and about 3 mm. Preferably the creasing channel has a width that is between about 0.5 mm and about 0.7 mm wider than the creasing ruler. Preferably, the difference in width between creasing channel and creasing ruler corresponds to about the double thickness of the base material.

Due to the applied forces during the creasing process, the counter roller should exhibit a hardness of between about 20 and about 100 Shore, preferably between about 70 and about 80 Shore. The counter roller is preferably made of metal or reinforced plastic material. The creasing channel is an integral part of the counter roller and preferably made of the same material as the counter roller.

The depth of the creasing lines, that is the distance from the upper side of the untreated cardboard to the upper side of the bottom of the crease, may vary. Typical values range from between about 0.1 mm and about 3 mm, preferably from between about 0.2 mm and about 2 mm, more preferably from between about 0.3 mm and about 1 mm. Preferably all creasing lines have the same depth along the entire length of the creasing lines. However, it is also possible that the individual creasing lines on an inner frame blank have different overall depths. Furthermore the depth of one specific creasing line may vary along the length of that creasing line.

The length of the creasing lines in the inner frame is, for example, at least about 5 mm, preferably at least about 7 mm and more preferably at least about 10 mm. Preferably, the length of the creasing lines in the inner frame does not exceed about 50 mm to about 150 mm, preferably about 60 mm to about 120 mm. The individual creasing lines may have different lengths, widths or depths and may be located at different positions on the inner frame.

In a preferred embodiment of the present invention, the at least one and preferably at least two creasing lines extend from at least about the right edge of the left side panel to at least about the left edge of the right side panel. Preferably, the at least one and preferably at least two creasing lines extend essentially over the entire width of the inner frame. It is also possible for the widths of the individual creasing to differ. Furthermore, it is possible that one or more of the creasing lines are interrupted, that is a given creasing line is a combination of a plurality of creasing lines and a number of gaps resulting in a dashed line.

The at least one and preferably at least two creasing lines may be linear or curved. The linear shape is preferred. The following curved shapes are, for example, possible: “S”-like shapes, sine-like shapes, and saw tooth-like shapes with peaks of the same or different amplitudes.

The preferably at least two creasing lines may be parallel or substantially parallel to each other. While generally a transverse direction is preferred, the at least one and preferably at least two creasing lines may also be slanted across the center panel, thus comprising a transverse and a longitudinal component. Alternatively or in addition, the preferably at least two creasing lines may cross each other across the center panel. Irregular orientations of the individual creasing lines are also possible, that is the orientations do not follow a regular pattern, but the individual creasing lines are skew relative to each other. The creasing lines may have the form of a logo or text.

For the preferred parallel or substantially parallel relative orientation if two or more creasing lines are present, the distance between the individual creasing lines is in a range of between about 0.1 mm and about 5.0 mm, preferably between about 0.2 mm and about 4 mm and particularly preferably between about 0.3 mm and about 3 mm.

In a particularly preferred embodiment, the preferably at least two creasing lines are linear and substantially parallel to each other, preferably at a distance in the range mentioned above.

Moreover, it is preferred if the angles formed by the preferably at least two creasing lines, which are preferably linear and substantially parallel to each other, and the mating edges of the right and left side panels and the center panel are each about 90 degrees.

The invention also refers to a container for consumer goods comprising a box, a lid which is preferably hingedly connected to the box and an inner frame as described above.

In a preferred embodiment of such a container for consumer goods, the inner frame is inserted into the box such that the inner frame extends partially beyond the upper end, which is the open end, of the box in the open position of the container but such that the at least one and preferably at least two creasing lines are not visible. The inner frame is typically glued to the inner side of the pack. Due to the above-described production method of the creasing lines, the inner frame has one side which is embossed (the side which was in contact with the creasing channel on the counter roller) and one side which is recessed (the side which was in contact with the creasing ruler on the roller). Preferably, the recessed side of the inner frame is glued to the inner side of the box front wall. This ensures proper gluing.

The present invention also refers to the use of an inner frame as described above to enhance the stability of a container, preferably a hinge lid container, for consumer goods.

In addition, the present invention also refers to a method of increasing the stability of a container, preferably a hinge lid container for consumer goods, the container comprising a box with an open end and a lid, preferably hingedly connected to the box, wherein an inner frame according to the present invention is inserted into the box such that at least a portion of this inner frame projects beyond the open end of the box. Preferably, the portion of the inner frame which carries the creasing lines of the present invention is inserted into the box such that the creasing lines are not visible to the consumer.

As pointed out above, the use of the inner frame according to the invention increases the overall strength and/or stability of a container for consumer goods when the inner frame is at least partially inserted into the box of the container for consumer goods. In particular, pack stability is increased along the direction of the at least one and preferably at least two creasing lines. For a conventional hinge lid container for consumer goods, the stability is increased in a transverse direction along the left side of the box to the right side of the box.

Containers according to the invention may be in the shape of a rectangular parallelepiped, with right-angled longitudinal and right-angled transverse edges. Alternatively, the container may comprise one or more rounded longitudinal edges, rounded transverse edges, bevelled longitudinal edges or bevelled transverse edges, or combinations thereof. For example, the container according to the invention may comprise, without limitation:
One or two longitudinal rounded or bevelled edges on the front wall, and/or one or two longitudinal rounded or bevelled edges on the back wall.
One or two transverse rounded or bevelled edges on the front wall, and/or one or two transverse rounded or bevelled edges on the back wall.
One longitudinal rounded edge and one longitudinal bevelled edge on the front wall, and/or one transverse rounded edge and one transverse bevelled edge on the back wall.
One or two transverse rounded or bevelled edges on the front wall and one or two longitudinal rounded or bevelled edges on the front wall.
Two longitudinal rounded or bevelled edges on a first side wall or two transverse rounded or bevelled edges on the second side wall.

Where the container comprises one or more rounded edges and is made from one or more laminar blanks, preferably the blanks comprise three, four, five, six or seven scoring lines or creasing lines to form each rounded edge in the assembled container. The scoring lines or creasing lines may be either on the inside of the container or on the outside of the container. Preferably, the scoring lines or creasing lines are spaced from each other by between about 0.3 mm and 4 mm.

Preferably, the spacing of the creasing lines or scoring lines is a function of the thickness of the laminar blank. Preferably, the spacing between the creasing lines or scoring lines is between about 0.5 and about 4 times larger than the thickness of the laminar blank.

Where the container comprises one or more bevelled edge, preferably the bevelled edge has a width of between about 1 mm and about 10 mm, preferably between about 2 and about 6 mm. Alternatively, the container may comprise a double bevel formed by three parallel creasing or scoring lines that are spaced such that two distinct bevels are formed on the edge of the container.

Where the container comprises a bevelled edge and is made from one or more laminar blanks, the bevel may be formed by two parallel creasing lines or scoring lines in the laminar blank. The creasing lines or scoring lines may be arranged symmetrically to the edge between a first wall and a second wall. Alternatively, the creasing lines or scoring lines may be arranged asymmetrically to the edge between the first wall and the second wall, such that the bevel reaches further into the first wall of the container than into the second wall of the container.

Alternatively, the container may have a non-rectangular transversal cross section, for example polygonal such as triangular or hexagonal, semi-oval or semi-circular.

Containers according to the invention find particular application as packs for elongate smoking articles such as, for example, cigarettes, cigars or cigarillos. Alternatively, they may be used for housing other tobacco industry articles like for example, snuff, snus, dissolvable tobacco strips, filters, filter tubes, aerosol generators, electrically heated cigarettes or components thereof.

It will be appreciated that through appropriate choices of the dimensions thereof, containers according to the invention may be designed for different numbers of conventional size, king size, super-king size, slim or super-slim cigarettes. Alternatively, other consumer goods may be housed inside the container.

Through an appropriate choice of the dimensions thereof, containers according to the invention may be designed to hold different total numbers of smoking articles, or different arrangements of smoking articles. For example, through an appropriate choice of the dimensions thereof, containers according to the invention may be designed to hold a total of between ten and thirty smoking articles.

The smoking articles may be arranged in different collations, depending on the total number of smoking articles. For example, the smoking articles may be arranged in a single row of six, seven, eight, nine or ten. Alternatively, the smoking articles may be arranged in two or more rows. The two or more rows may contain the same number of smoking articles. For example, the smoking articles may be arranged in: two rows of five, six, seven, eight, nine or ten; three rows of five or seven; or four rows of four, five or six. Alternatively, the two or more rows may include at least two rows containing different number of smoking articles to each other. For example, the smoking articles may be arranged in: a row of five and a row of six (5-6); a row of six and a row of seven (6-7); a row of seven and a row of eight (7-8); a middle row of five and two outer rows of six (6-5-6); a middle row of five and two outer rows of seven (7-5-7); a middle row of six and two outer rows of five (5-6-5); a middle row of six and two outer rows of seven (7-6-7); a middle row of seven and two outer rows of six (6-7-6); a middle row of nine and two outer rows of eight (8-9-8); or a middle row of six with one outer row of five and one outer row of seven (5-6-7).

Containers according to the present invention may hold smoking articles of the same type or brand, or of different types or brands. In addition, both filterless smoking articles and smoking articles with various filter tips may be contained, as well as smoking articles of differing length (for example, between about 40 mm and about 180 mm), diameter (for example, between about 4 mm and about 9 mm). In addition, the smoking articles may differ in strength of taste, resistance to draw and total particulate matter delivery. Preferably, the dimensions of the container are adapted to the length of the smoking articles, and the collation of the smoking articles. Typically, the outer dimensions of the container are between about 0.5 mm to about 5 mm larger than the dimensions of the bundle or bundles of smoking articles housed inside the container.

The length, width and depth of containers according to the invention may be such that in a closed position, the resultant overall dimensions of the container are similar to the dimensions of a typical disposable hinge lid pack of twenty cigarettes.

Preferably, containers according to the invention have a height of between about 60 mm and about 150 mm, more preferably a height of between about 70 mm and about 125 mm, wherein the height is measured from the bottom wall to the top wall of the container.

Preferably, containers according to the invention have a width of between about 12 mm and about 150 mm, more preferably a width of between about 70 mm and about 125 mm, wherein the width is measured from one side wall to the other side wall of the container.

Preferably, containers according to the invention have a depth of between about 6 mm and about 150 mm, more preferably a depth of between about 12 mm and about 25 mm wherein the depth is measured from the front wall to the back wall of the container.

Preferably, the ratio of the height of the container to the depth of the container is in between about 0.3 to 1 and about 10 to 1, more preferably between about 2 to 1 and about 8 to 1, most preferably between about 3 to 1 and about 5 to 1.

Preferably, the ratio of the width of the container to the depth of the container is in between about 0.3 to 1 and about 10 to 1, more preferably between about 2 to 1 and about 8 to 1, most preferably between about 2 to 1 and about 3 to 1.

In addition to the pattern on the center panel, the interior surfaces or exterior surfaces of containers or both interior and exterior surfaces of containers according to the invention may be printed, embossed, debossed or otherwise embellished with manufacturer or brand logos, trade marks, slogans and other consumer information and indicia.

The consumer goods within the containers according to the invention may be individually wrapped. This has the advantage, that once the container according to the invention is opened and a first consumer good is removed, the remainder of the consumer goods are still wrapped and remain such protected from dust, sunlight or other environmental influences.

Once filled, containers according to the invention may be shrink wrapped or otherwise over wrapped with a transparent polymeric film of, for example, high or low density polyethylene, polypropylene, oriented polypropylene, polyvinylidene chloride, cellulose film, or combinations thereof in a conventional manner. Where containers according to the invention are over wrapped, the over wrapper may include one or more a tear tapes. In addition, the over wrapper may be printed with images, consumer information or other data.

The invention will be described, by way of example only, with reference to the accompanying drawings in which:

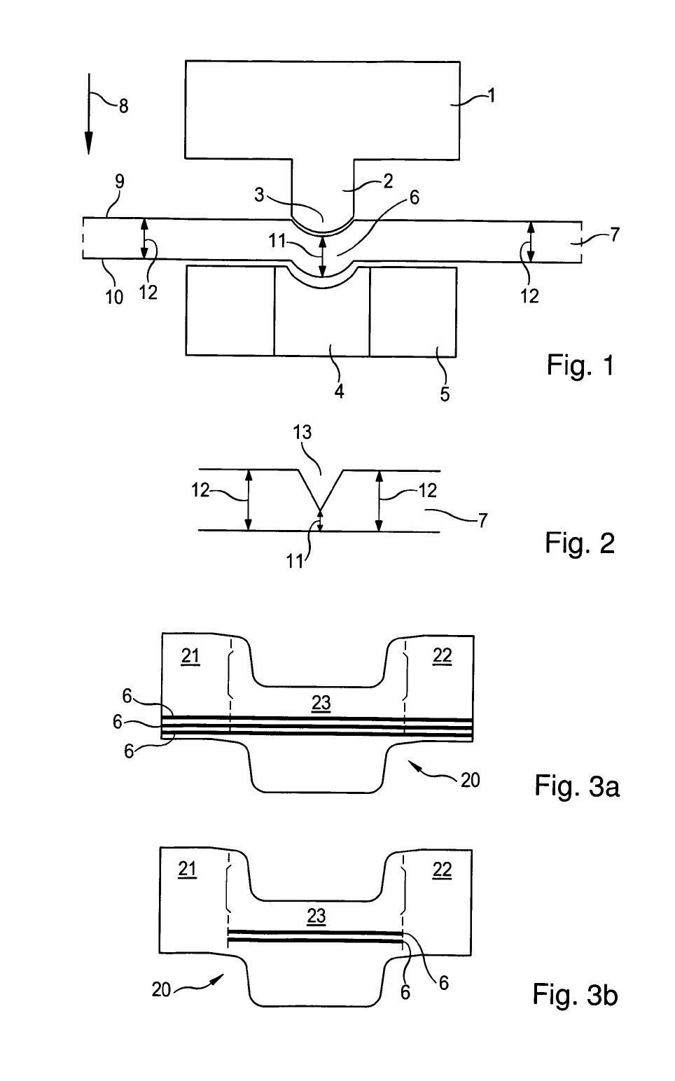

FIG. 1 shows the production of a crease according to the invention;

FIG. 2 shows the difference between a creasing line and a scoring line;

FIG. 3a shows an inner frame according to the invention with creasing lines which extend over the entire width of the inner frame;

FIG. 3b shows an inner frame according to the invention with creasing lines which extendonly over the center portion of the inner frame.

In FIG. 1 roller 1 carries creasing ruler 2 with top 3. Creasing channel 4 is an integral part of counter roller 5. Crease or creasing line 6 is applied to cardboard 7 by applying force in the direction of arrow 8 to the upper side 9 of cardboard 7. Meanwhile, lower side 10 of cardboard 7 is pushed into creasing channel 4 by top 3 of creasing ruler 2 such that crease 6 is created. The thickness 11 of crease 6 is the same as the thickness 12 of the untreated cardboard.

In FIG. 2 cardboard 7 is shown with a score 13 made by a scoring instrument (not shown) such as a knife. Thickness 11 of the cardboard at the center position of score 13 is lower than thickness 12 of the untreated cardboard. Compared to FIG. 1, the difference between crease 6 and score 13 becomes evident. A fold line would have a very similar appearance as the scoring line shown in FIG. 2.

FIG. 3a shows an inner frame 20 with left and right side panels 21, 22 and center panel 23. Three creasing lines 6 extend over the entire width of inner frame 20 from the left edge of left side panel 21 to the right edge of right side panel 22.

FIG. 3b shows an inner frame 20 with left and right side panels 21, 22 and center panel 23. Two creasing lines 6 are located on center panel 23 and extend from the right edge of left side panel 21 to the left edge of right side panel 22.

1. An inner frame blank for containers for consumer goods with a lid and a box the inner frame blank comprising a center panel and a left side panel and a right side panel, each adjacent to said center panel, wherein said inner frame comprises at least one substantially transverse creasing line extending partially or completely from the left side panel to the right side panel across said center panel and in that said at least one creasing line extends from at least a right edge of said left side panel to at least a left edge of said right side panel.

2. (canceled)

3. The inner frame blank according to claim 1, wherein the creasing lines are linear or curved.

4. The inner frame blank according to claim 1, wherein said inner frame comprises at least two substantially transverse creasing lines extending partially or completely across said center panel.

5. The inner frame blank according to claim 4, wherein said creasing lines are linear and substantially parallel to each other, with a distance between each creasing line of between about 0.5 mm and about 3.0 mm.

6. The inner frame blank according to claim 5, wherein the creasing lines and the mating edges of said right side panel and the center panel form an angle of about 90 degrees and wherein the mating edges of said left side panels and the center panel form an angle of about 90 degrees.

7. The inner frame blank according to claim 1, wherein the inner frame blank comprises or is made from short-grain paper or short-grain cardboard.

8. A container for consumer goods comprising a box, a lid and an inner frame blank according to claim 1 wherein the inner frame blank forms the inner frame of the container.

9. The container for consumer goods according to claim 8, wherein said inner frame blank is inserted into said box such that it extends partially beyond an upper end of said box in the open position of said container such that said creasing lines are below an upper edge of the box front wall.

10. The container according to claim 8, wherein the lid is hingedly connected to the box of the container.

11. The container according to claim 8, wherein the container comprises smoking articles.

12. The container according to claim 8, wherein the container and the inner frame blank comprise or are made from short-grain paper or short-grain cardboard.

13. Use of an inner frame according to claim 1 to enhance the stability of a container for consumer goods.

14. A method of increasing the stability of a container for consumer goods, comprising the steps of
providing a container comprising a box with an open end and a lid,
providing an inner frame blank, the inner frame blank comprising at least one, creasing line extending partially or completely across said inner frame blank,
inserting said inner frame blank into said box such that at least a portion of said inner frame blank projects beyond an upper end of said box.

15. The method of claim 14, wherein said inner frame is inserted into said box such that said creasing lines are not visible to consumers.

16. The method of claim 14, wherein the providing an inner frame blank step comprises the inner frame block comprising at least two creasing lines extending partially or completely across said inner frame blank.

17. The inner frame blank according to claim 1, formed from a laminar cardboard blank or paperboard blank which cardboard or paperboard has a weight in a range of about 100 grams per square meter to about 350 grams per square meter.

18. The inner frame blank according to claim 1, wherein said at least one creasing line has a depth in a range of about 0.2 mm to about 2 mm.

19. The container according to claim 8, comprising one or two longitudinal rounded or beveled edges on a front wall, or one or two longitudinal rounded or beveled edges on a back wall.

20. The container according to claim 8, wherein said inner frame blank is glued to an inner side of the pack.

21. The container according to claim 20, wherein a recessed side of said inner frame blank is glued to an inner side of the box front wall.
